(19) United States
(12) Patent Application Publication
(10) Pub. No.: US 2006/0042620 A1
(43) Pub. Date: Mar. 2, 2006

(54) Portable vertical gas grill

(76) Inventor: Eugene H. Luoma, Duluth, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 10/930,509

(22) Filed: Aug. 31, 2004

(51) Int. Cl. F24C 3/00; A47J 37/00

(52) U.S. Cl. 126/25 R; 126/41 R; 126/39 B

(57) ABSTRACT

A portable gas grill for cooking food, consists of a substantially vertical housing; a substantially horizontal burner within the housing; a gas supply; a control valve connecting the gas supply to the burner; an igniter; and a substantially vertically oriented food retaining unit insertable into and removable from the housing above the burner.

### BACKGROUND OF THE INVENTION

The present invention relates to a portable gas grill and in particular to a portable gas grill in which the grill housing is vertically oriented and in which food is cooked in a vertical orientation within a grilling basket.

Portable barbecue grills fired by pressurized hydrocarbon fuels are readily available from a wide range of manufacturers and retailers. However, such units are adapted solely for the cooking of products on a grill, defined herein as a large number of horizontally oriented rods aligned parallel to one another and retained in their alignment by cross-members, resulting in a majority of open space through which heat from a burner element may be directed onto the food to be cooked. The cooking of many foods is impossible on such units, for it would fall into the open spaces between the grill rods. For instance, eggs, pancakes, stir-fry or Oriental dishes, etc., could not be cooked on conventional units.

Furthermore, heat rising from the burner element is wasted once it reaches the grill, as the heat will naturally tend to rise to the highest point within the grill enclosure above the food.

In addition, food cooking on the horizontal grill surface must be flipped repeatedly so that both sides of the food are evenly cooked.

There is a need for a portable, vertical gas grill that addresses these problems.

### SUMMARY OF THE INVENTION

A portable gas grill for cooking food, comprising:
(a) a substantially vertical housing;
(b) a substantially horizontal burner within the housing;
(c) a gas supply;
(d) a control valve connecting the gas supply to the burner;
(e) an igniter; and
(f) a substantially vertically oriented food retaining unit insertable into and removable from the housing above the burner.

A principal object of and advantage of the present invention is that the housing is vertically oriented and therefore takes up less space on a table or other surface than a conventional gas grill.

Another principal object and advantage of the present invention is that it uses gas more efficiently than other grills because the rising heat cooks the food as it rises vertically past the vertically oriented food.

Another principal object and advantage of the present invention is that it has a closable basket for retaining food vertically within the grill, and thus can be used for cooking a great variety of foods without any danger of the food falling out of the basket.

Another principal object and advantage of the present invention is that the grill basket makes it unnecessary for the user to flip the food as it is cooking.

Another object and advantage of the present invention is that all components including the tank of propane gas are portable without disassembly.

### BRIEF DESCRIPTION OF THE DRAWINGS

FIG. 1 is a perspective view of the gas grill of the present invention.

FIG. 2 is a top perspective view of the gas grill of the present invention.

FIG. 3 is a front perspective view of the gas grill of the present invention.

FIG. 4 is a front perspective view of the housing of the gas grill of the present invention.

FIG. 5 is a bottom perspective view of the housing of the gas grill of the present invention.

FIG. 6 is a perspective view of one embodiment of a burner for the gas grill of the present invention.

FIG. 7 is a bottom perspective view of the housing and burner of FIG. 6.

FIG. 8 is a is a detail of FIG. 7.

FIG. 9 is a rear view of the housing of the present invention showing interior parts.

FIG. 10 is a detailed rear view of the housing of the present invention showing an attached smoke box.

FIG. 11 is a rear perspective view of the housing of the present invention showing the grilling basket in place.

FIG. 12 is a detailed view of the top of the housing of the present invention showing the vent and handle.

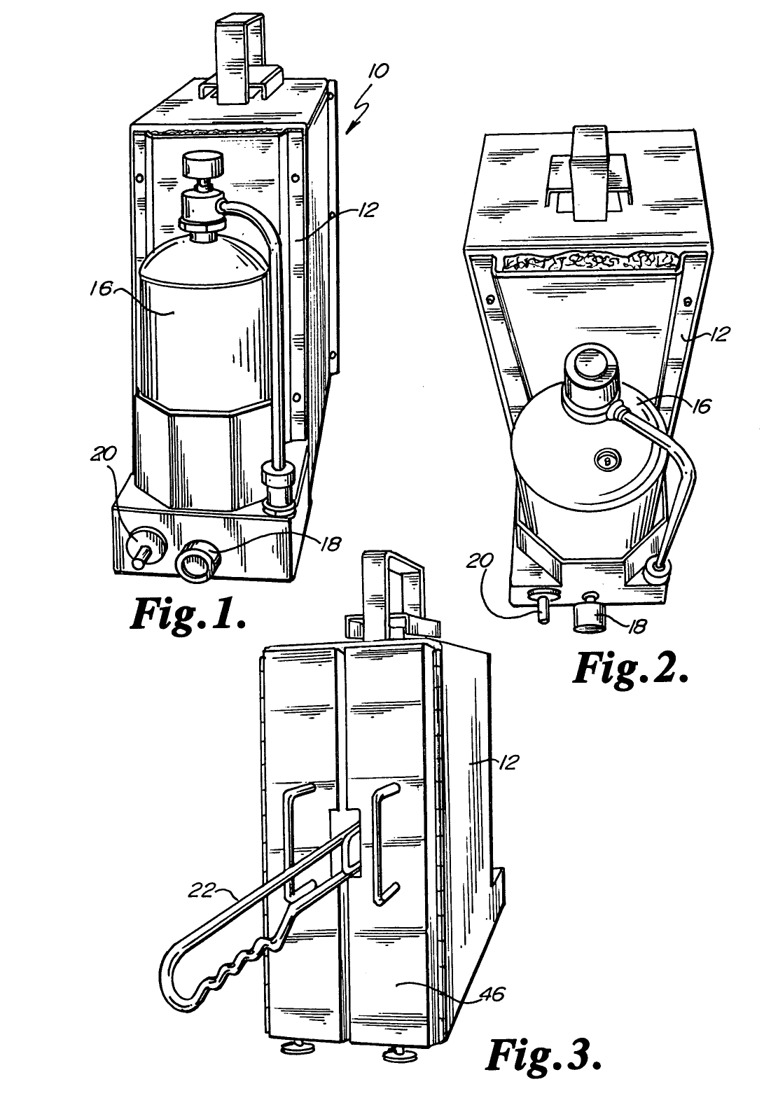

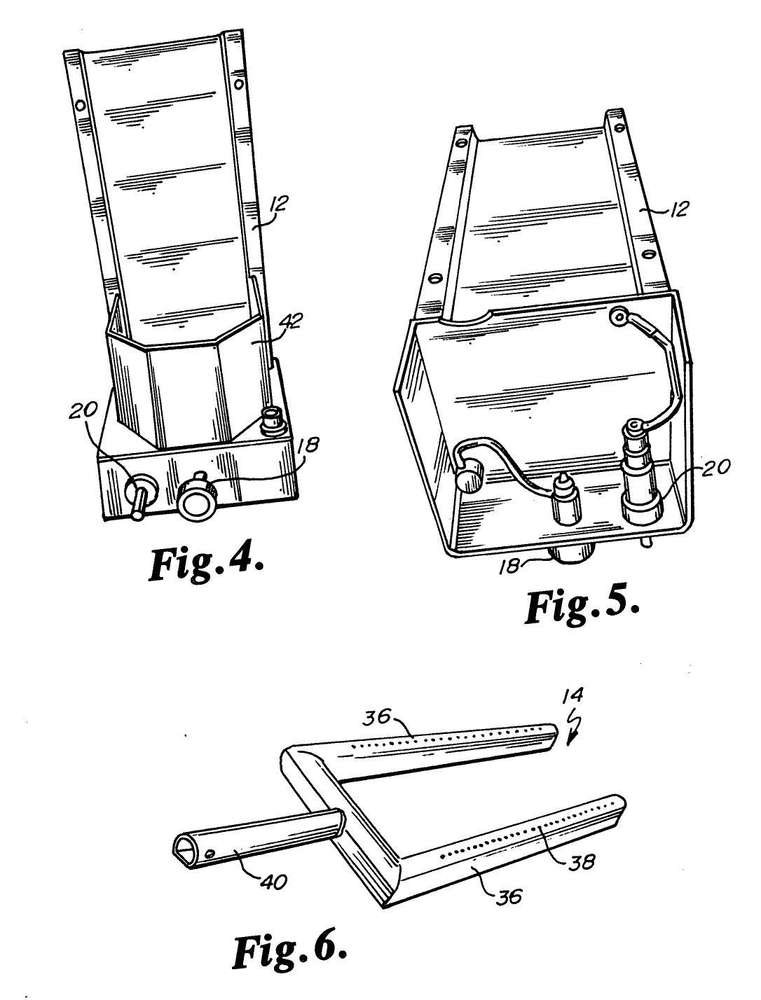

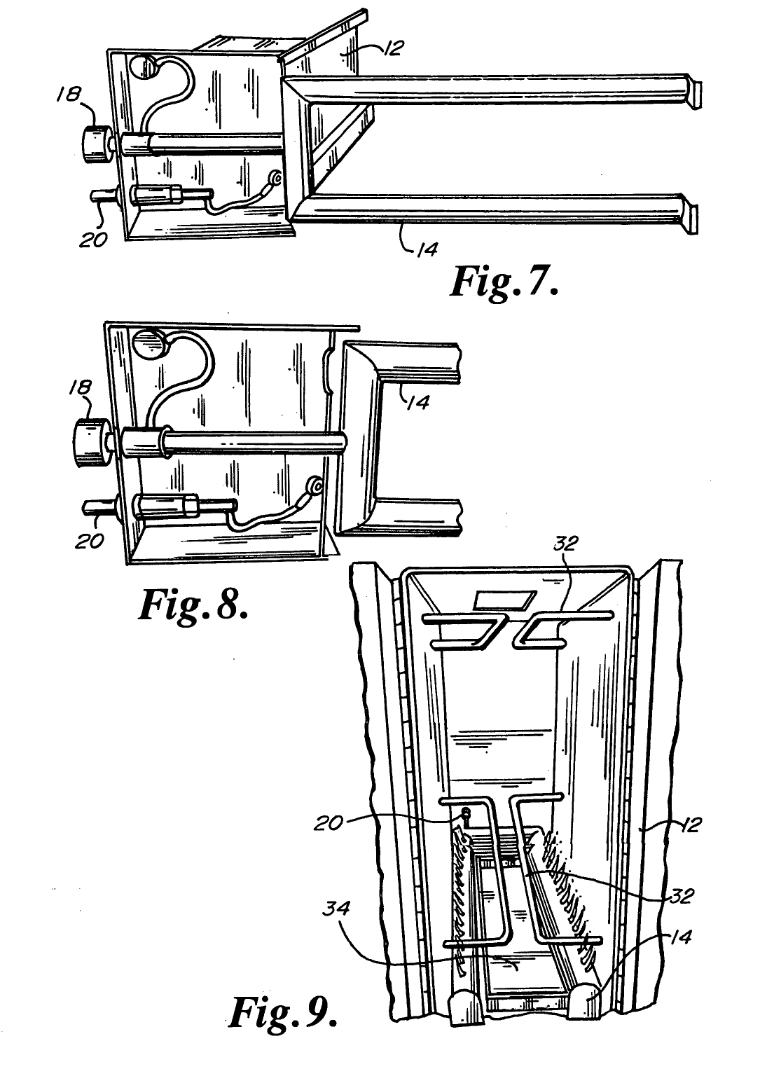

### DETAILED SPECIFICATION

The portable gas grill of the present invention is generally shown in the Figures as reference numeral 10.

The portable gas grill 10 further comprises a substantially vertical housing 12, a substantially horizontal burner 14 within the housing 12, a gas supply 16, a control valve 18 connecting the gas supply 16 to the burner 14, an igniter 20, and a substantially vertical food retaining unit 22 insertable into and removable from the housing 12 above the burner 14.

Preferably, the substantially vertical food retaining unit 22 further comprises a basket 24 having two sides 26, 28, each side having a plurality of openings 30.

Preferably, the gas grill 10 further comprises a support 32 within the housing 12 for retaining the basket 24 in a substantially vertical position.

In one embodiment, the gas grill 10 further comprises a drip tray 34 beneath the basket 24.

In one embodiment, the burner 14 further comprises a plurality of substantially parallel tubes 36 having flame openings 38 and a manifold 40 connecting the tubes 36 to the control valve 18.

In one embodiment, the gas grill 10 further comprises an enclosure 42 for the gas supply mounted on the housing 12. Preferably, the enclosure 42 is adapted to hold a propane tank 44.

Preferably, the gas grill 10 further comprises a vertically mounted door 46 pivotable on the housing 12 between an open position and a closed position.

The gas grill 10 may also preferably comprise a handle 48 mounted on the top of the housing 12. Preferably, a vent 50 is included in the housing 12 under the handle 48.

In one embodiment, the gas grill 10 further comprises a removable container 52 within the housing 12 adapted to contain wood chips for smoking foods.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

1. A portable gas grill for cooking food, comprising:
(a) a substantially vertical housing;
(b) a substantially horizontal burner within the housing;
(c) a gas supply;
(d) a control valve connecting the gas supply to the burner;
(e) an igniter; and
(f) a substantially vertically oriented food retaining unit insertable into and removable from the housing above the burner.

2. The gas grill of claim 1, wherein the substantially vertically-oriented food retaining unit further comprises a basket having two sides, each side having a plurality of openings.

3. The gas grill of claim 2, further comprising a support within the housing for retaining the basket in a substantially vertical position.

4. The gas grill of claim 2, further comprising a drip tray beneath the basket.

5. The gas grill of claim 1, wherein the burner further comprises a plurality of substantially parallel tubes having flame openings and a manifold connecting the tubes to the control valve.

6. The gas grill of claim 1, further comprising an enclosure for the gas supply mounted on the housing.

7. The gas grill of claim 6, wherein the enclosure is adapted to hold a propane tank.

8. The gas grill of claim 1, further comprising a vertically mounted door pivotable on the housing between an open position and a closed position.

9. The gas grill of claim 1, further comprising a handle mounted on the top of the housing.

10. The gas grill of claim 9, further comprising a vent in the housing under the handle.

11. The gas grill of claim 1, further comprising a removable container within the housing adapted to hold wood chips for smoking foods.

12. A portable gas grill for cooking food, comprising:
(a) a substantially vertical housing;
(b) a substantially horizontal burner within the housing;
(c) a gas supply;
(d) a control valve connecting the gas supply to the burner;
(e) an igniter; and
(f) a substantially vertically oriented grill basket insertable into and removable from the housing above the burner and a support within the housing for retaining the basket in a substantially vertical position.

13. The gas grill of claim 12, further comprising a drip tray beneath the basket.

14. The gas grill of claim 12, wherein the burner further comprises a plurality of substantially parallel tubes having flame openings and a manifold connecting the tubes to the control valve.

15. The gas grill of claim 12, further comprising an enclosure for the gas supply mounted on the housing.

16. The gas grill of claim 15, wherein the enclosure is adapted to hold a propane tank.

17. The gas grill of claim 12, further comprising a vertically mounted door pivotable on the housing between an open position and a closed position.

18. The gas grill of claim 12, further comprising a handle mounted on a the top of the housing.

19. The gas grill of claim 18, further comprising a vent in the housing under the handle.

20. The gas grill of claim 12, further comprising a removable container within the housing adapted to hold wood chips for smoking foods.

21. A portable gas grill for cooking food, comprising:
(a) a substantially vertical housing;
(b) a substantially horizontal, U-shaped burner within the housing;
(c) a propane tank;
(d) a control valve connecting the propane tank to the burner;
(e) an igniter;
(f) a substantially vertically oriented grill basket insertable into and removable from the housing above the burner and a support within the housing for retaining the basket in a substantially vertical position;
(g) an enclosure for the propane tank mounted on the housing; and
(h) a vertically mounted door pivotable on the housing between an open position and a closed position.
